(19) United States
(12) Patent Application Publication
(10) Pub. No.: US 2021/0017617 A1
(43) Pub. Date: Jan. 21, 2021

(54) METHOD FOR GENERATING METALLIC COMPONENTS HAVING CUSTOMISED COMPONENT PROPERTIES

(71) Applicant: voestalpine Stahl GmbH, Linz (AT)

(72) Inventors: Andreas Pichler, Vocklabruck (AT); Thomas Kurz, Linz (AT); Johannes Rehrl, Linz (AT)

(73) Assignee: voestalpine Stahl GmbH, Linz (AT)

(21) Appl. No.: 16/955,961

(22) PCT Filed: Dec. 21, 2018
(86) PCT No.: PCT/EP2018/086661

§ 371 Date: Jun. 19, 2020

(30) Foreign Application Priority Data
Dec. 22, 2017 (DE) 10 2017 131 247.1

(51) Int. Cl. C21D 1/673; C21D 7/13; C21D 8/06; C22C 38/02; C22C 38/04; C22C 38/06; C22C 38/26; C22C 38/28

(52) U.S. Cl. CPC C21D 1/673; C21D 7/13; C21D 8/065; C22C 38/02; C21D 2211/005; C22C 38/06; C22C 38/26; C22C 38/28; C21D 2211/001; C22C 38/04

(57) ABSTRACT

The invention relates to a method for producing a sheet steel component by means of a press hardening or form hardening process, the sheet steel component being produced by virtue of the fact that a sheet bar composed of a dual-phase steel is cold-formed, then heated, and then quenched in a cooling press or a sheet bar composed of a dual-phase steel is heated to a temperature above the austenitization temperature of the highly hardenable steel material and is then formed into the sheet steel component in a single stroke or in a plurality of strokes in a forming and cooling press, wherein a dual-phase steel is used, whose Ac3 value is increased until at the required annealing temperatures, only a partial austenitization of the dual-phase steel takes place so that when loaded into the cooling press, the dual-phase steel has a ferritic matrix, and in addition to this, austenite is present.

The invention relates to a method for producing metallic components according to the preamble of claim 1. The invention particularly relates to a method for producing steel sheets and steel components made from them

In the past, there has been a need, for energy-saving reasons, to design lighter-weight vehicles and in particular, lighter-weight vehicle bodies. It has also been necessary, however, to make vehicle bodies more stable and in particular, to effectively protect the passenger compartment in the event of an accident. Correspondingly, in the past, this has been distilled down to the fact that the body of vehicles was at least partially constructed of very highly hardenable steels (CMnB steels). These highly hardenable steels are produced in sheet form, then formed, and then the formed components are heated to very high temperatures until they are completely austenitized, and then are transferred to a cooling press and in this cooling press, are cooled through contact on all sides with cold tool jaws or forms at a speed that is above the critical hardening speed so that the completely austenitized component is at least predominantly in the martensitic phase, which enables achievement of hardnesses of up to more than 1500 MPa. This method, in which first shaping, then hardening, and then cooling through placement in the form are carried out, is also referred to as the indirect method or form hardening.

In so-called press hardening, the sheet bar composed of the highly hardenable steel is heated to a temperature above the austenitization temperature and is austenitized as completely as possible. Then this sheet bar in the austenitized state is transferred to a forming tool and with one press stroke or a plurality of press strokes, is both formed and hardened by the significant thermal outflow from the sheet bar into the forming tool. This method is also referred to as the direct method or the multiform method.

Through these two methods, it was and is essentially possible to design a vehicle body with very hard parts and to produce the rest of the body in a correspondingly graduated fashion out of parts with different ductilities and hardnesses.

A modern vehicle body thus consists of a number of load-conveying high-strength components and also soft, deformable elements for energy absorption.

However, hot forming is used not only on highly hardenable CMnB steels, but also on other steel grades, particularly in order to take advantage of their better deforming behavior when hot in order to achieve complex component geometries.

As with the sheet metals mentioned above, steel sheets in this context can undergo changes in structure due to the temperature.

If such a hot steel sheet is loaded into a cold form, it has turned out that different cooling conditions can prevail particularly during the loading of the sheet, but also during the time from its removal from the furnace to its loading into the form and that different cooling conditions can also prevail in the form. This can make it difficult to adhere to tolerances.

The object of the invention is to create a method for producing hot-formed sheet metal components with consistent properties and stable mechanical characteristic values in a simple and inexpensive way.

The object is attained with a method having the features of claim 1.

Another object of the invention is to create a material that ensures stable mechanical characteristic values independent of the cooling situation and independent of the cooling sequence.

This object is attained with a material having the features of claim 10.

Advantageous modifications are disclosed in the claims that are dependent thereon.

According to the invention, the material is made of a steel with a dual-phase structure (DP steel). The dual-phase structure according to the invention consists of a ferritic matrix with embedded martensite inclusions. Through the enormous strengthening capacity, this enables the achievement with the same strength of a significantly better formability in the sense of the ultimate elongation and thus higher energy absorption than the ferritic-perlitic structure that is known in the prior art. These steels with a dual-phase structure according to the invention therefore work very well.

Known dual-phase steels are disclosed, for example, by EP 2 896 715 B1, which describes a dual-phase steel with titanium precipitation hardening.

EP 2 290 111 B1 discloses a dual-phase steel with a ferritic structure for automobiles.

JP 2009/132981 A discloses a ferritic cold-rolled steel with a high degree of formability.

WO2017/144419 A1 discloses a press hardened steel with a dual-phase structure.

US 2010/0221572 A1 discloses a press hardened steel with a structure composed of ferrite, bainite, and martensite.

DE 10 2014 11 21 26 A1 discloses a microalloyed steel with a given cooling rate number.

EP 2 896 715 B1 discloses a dual-phase steel with titanium precipitation hardening.

According to the invention, it has been discovered that in order to achieve a ferritic-martensitic dual-phase structure in the hot forming or press hardening, the formation of perlite and bainite must be delayed in such a way that these structural phases do not occur at the usual cooling rates.

According to the invention, in order to delay the formation of perlite and bainite, manganese, chromium, boron, and molybdenum are added to the alloy. It has turned out, however, that this also delays the formation of ferrite after the fully austenitic annealing in the furnace, which is critical with short transfer times between the furnace and press, high loading temperatures, and high cooling rates in the press.

As a result, a structure can form, which consists of a tempered martensitic matrix with little ferrite, which while achieving high strengths, only has low elongations. Only at lower cooling rates in the press do stable mechanical characteristic values occur, regardless of the loading temperature in the press.

According to the invention, in order to ensure the presence of a sufficient quantity of ferrite and thus a ferritic matrix in the structure, the material is annealed in the furnace in such a way that in addition to austenite, ferrite is also present. Thus according to the invention, intercritical annealing occurs in the furnace. Intercritical annealing means that the material is annealed between its Ac1 and Ac3 temperatures.

The ferrite quantity required to constitute a ferritic matrix is achieved during the cooling between the furnace and press, not only by the ferrite nucleation with subsequent ferrite growth, but also by the steady growth of the ferrite that is present due to the intercritical annealing. According to the invention, therefore, the Ac3 temperature for the steel must be kept high in order for an intercritical annealing to even be possible. According to the invention, the Ac3 value is increased by means of aluminum.

According to the invention, therefore, the dual-phase steel is embodied with an elevated aluminum content. Consequently, a fully austenitic annealed state is impeded as a function of the alloy. In this case, the annealing temperature is set to about >800° C. so that this annealing value must be assumed as a given for the intercritical annealing.

The concept of the invention thus basically consists of a C—Si—Mn—Cr—Al—Nb/Ti alloy concept.

The carbon contained in it is used to adjust the strength level; a higher carbon content reduces the Ac3 value, increases the strength, and likewise increases the yield strength. But the elongation decreases, the formation of ferrite, perlite, and bainite is delayed, and the martensite quantity in the structure increases.

The purpose of the manganese is to adjust the strength level. More manganese decreases the Ac3 value; it also increases the strength and the yield strength. With a higher manganese content, the elongation decreases, the formation of ferrite, perlite, and bainite is delayed, and the martensite quantity in the structure increases.

As already explained above, with the concept according to the invention, aluminum is used because more aluminum increases the Ac3 value, which reduces the sensitivity to the loading temperature in the press. In addition, improvements in the elongation are achieved, the martensite quantity in the structure decreases, and the ferrite quantity increases.

In the alloy according to the invention, silicon increases the strength level, increases the Ac3 value, and delays the formation of perlite and bainite.

Table 1 lists typical values of Ae1 temperatures and Ae3 temperatures for DP steels according to the invention as well as for alloys not according to the invention. These calculated values essentially correspond to the Ac1 temperatures and Ac3 temperatures.

In the exemplary embodiments not according to the invention, either an excessively low Ae1 temperature or Ae3 temperature is achieved by the respectively selected alloy composition and/or the desired mechanical characteristic values are not achieved (for example due to excessively low silicon percentages).

The chromium primarily delays the formation of perlite and bainite and ensures the formation of martensite so that chromium has a significant influence on ensuring the dual-phase nature.

Niobium and titanium force the formation of ferrite and have a grain-refining influence.

According to the invention, it is thus sufficient to provide a steel material in the form of a dual-phase steel, which supplies stable mechanical characteristic values independently of the cooling situation and thus yields reliably achieved and embodied tailored welded blanks in the press hardening or form hardening process.

The invention will be explained by way of example based on the drawings. In the drawings:

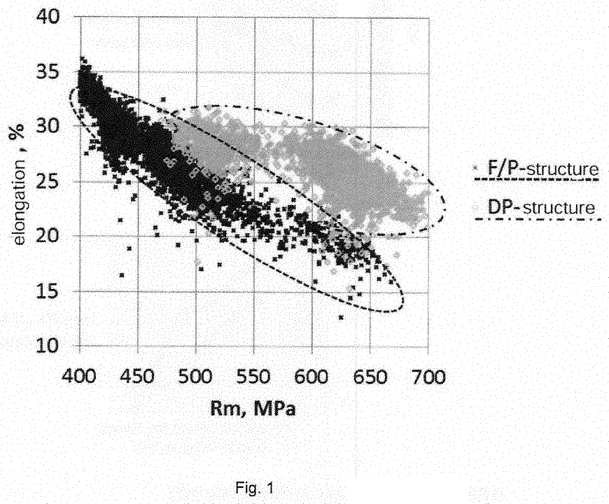

FIG. 1: shows the elongation and strength of dual-phase structures and ferritic-perlitic structures according to the prior art;

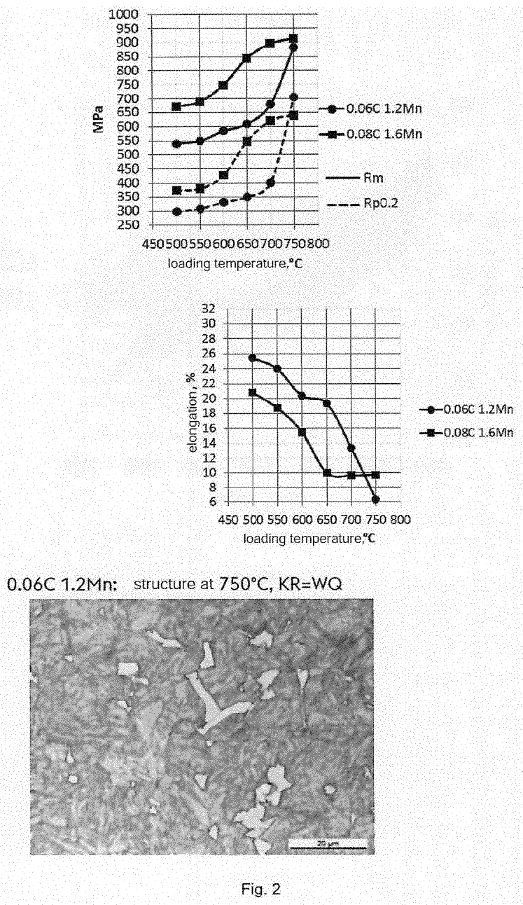

FIG. 2: shows the behavior of fully austenitically annealed dual-phase steels with high cooling rates in the press, first showing the strength as a function of the loading temperature and then showing the elongation as a function of the loading temperature as well as the achievable structure;

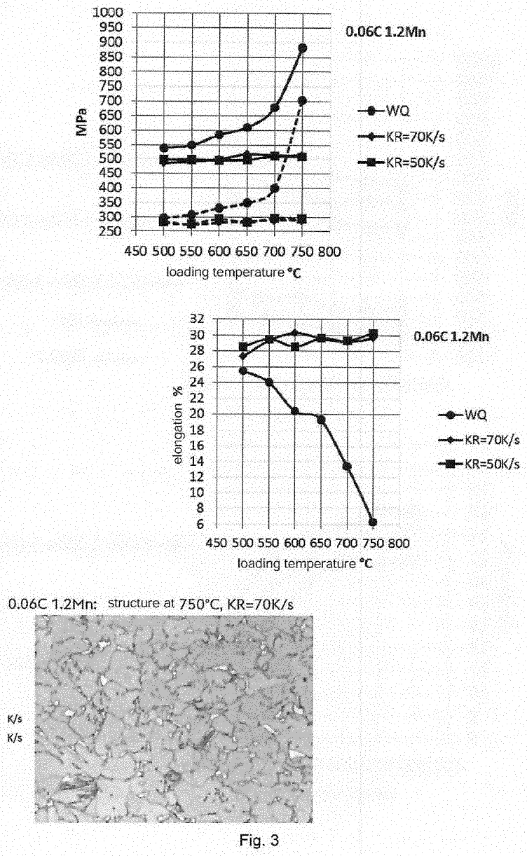

FIG. 3: shows the behavior of fully austenitically annealed dual-phase steels at high and low cooling rates in the press;

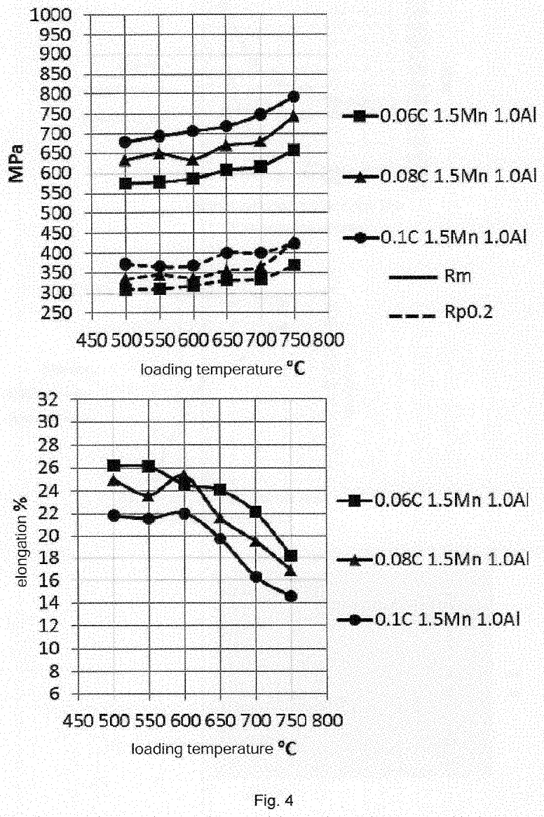

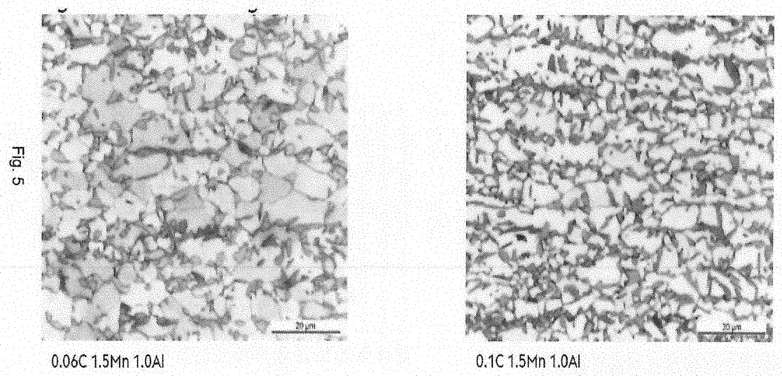

FIG. 4: shows the influence of carbon on the mechanical characteristic values as a function of the loading temperature;

FIG. 5: shows structure images of dual-phase steels with different carbon contents;

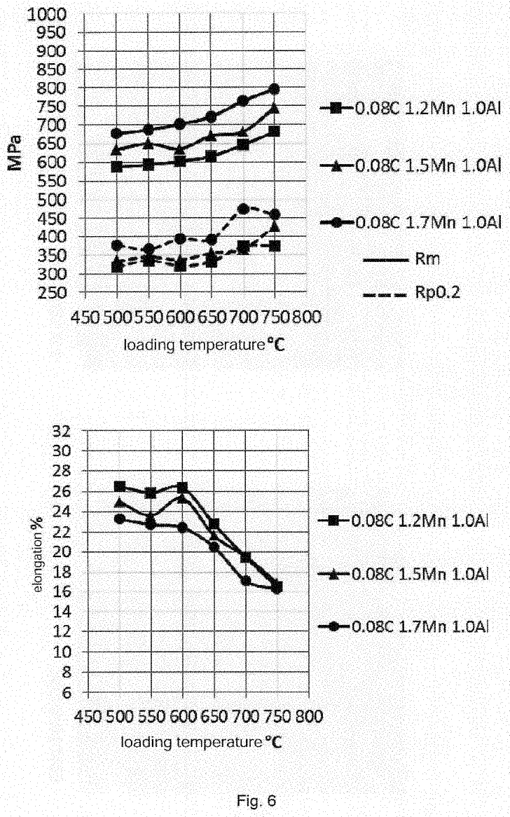

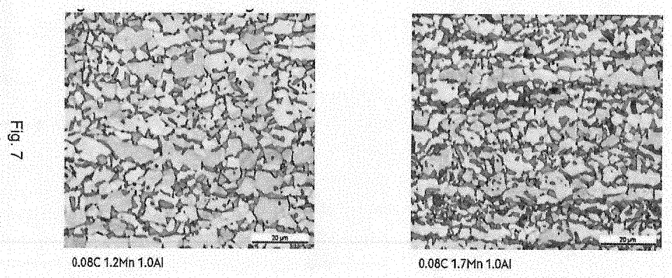

FIG. 6: shows the influence of manganese on the mechanical characteristic values;

FIG. 7: shows the structure images with different manganese contents;

FIG. 9: shows the structure images with different aluminum contents;

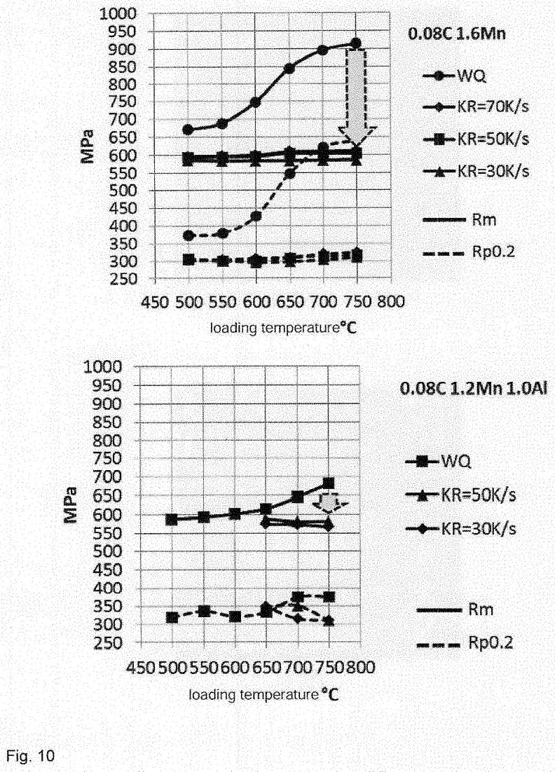

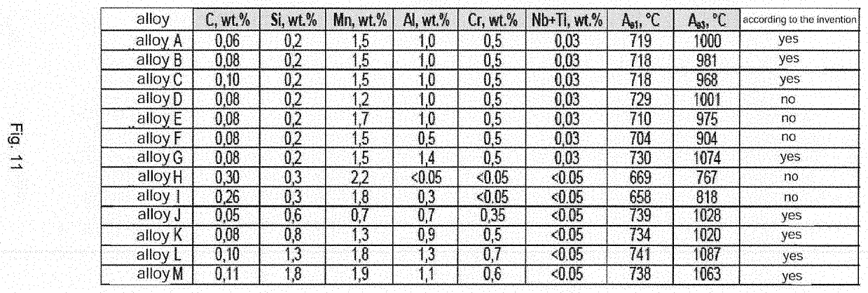

FIG. 10: shows the influence of the intercritically annealed aluminum-alloyed dual-phase steel concept according to the invention in comparison to fully austenitically annealed carbon/manganese alloys.

The method according to the invention provides producing a sheet metal component out of a flat sheet part composed of a dual-phase steel in the press hardening or form hardening process.

Such a flat component composed of the DP steel according to the invention can therefore be sufficiently heated and then formed or else formed and then heated and quenched.

According to the invention, a dual-phase steel with a relatively high aluminum content is used. According to the invention, it has been discovered that aluminum decreases the sensitivity of the mechanical characteristic values to the loading temperature and sharply decreases their sensitivity to the cooling rate in the press.

With high cooling rates in the press, simple carbon/manganese alloys, which are fully austenitically annealed in the furnace, are highly dependent on the loading temperature.

The composition of the dual-phase steel according to the invention is as follows, with all percentages being indicated in mass percent:

| | |
|---|---|
| C | 0.02-0.12%, preferably 0.04-0.10% |
| Si | 0.5-2.0%, preferably 0.55-1.50% |
| Mn | 0.5-2.0%, preferably 0.6-1.50% |
| Cr | 0.3-1.0%, preferably 0.45-0.80% |
| Al | 0.5-1.5%, preferably 0.60-1.20% |
| Nb | <0.20%, preferably 0.01-0.10% |
| Ti | <0.20%, preferably 0.01-0.10% |

Residual quantities of iron and inevitable smelting-related impurities.

With a dwell time in the furnace of up to 600 seconds, in particular up to 300 seconds, at annealing temperatures of about 840° C., only a partial austenitization is achieved with regard to the dual-phase steel.

The degree of austenitization that occurs in the dual-phase steel is between 50 and 90% by volume, with the desired structure being a fine dual-phase steel with ferritic matrix and 5 to 20% by volume martensite and possibly some bainite.

The desired structure occurs if the following cooling sequence is maintained and thus if—during the manipulation of the component or sheet bar in the cooling press, i.e. during handling—a cooling rate of 5 to 550 Kelvin/sec is maintained and the loading temperature in the cooling press is 400 to 850° C., preferably 450 to 750° C. In the form hardening process, i.e. a process in which first, a cold forming is carried out and the cold formed component is then heated and in a form hardening tool, is rapidly cooled and held, the loading temperature is preferably 700° C. to 850° C. In the press hardening process, i.e. a process in which a flat sheet bar is heated and then formed and cooled in a press hardening tool, the loading temperature is preferably 400° C. to 650° C., more preferably 440° C. to 600° C., and particularly preferably 450° C. to 520° C.

A particular effect in the press hardening process, i.e. the direct method, is that particularly with a loading temperature of 450 to 520° C., the structure can be established in an optimal way, yielding a system that is particularly robust with regard to cooling rates.

The cooling rate in the press should be ≥10 Kelvin/sec.

To achieve this, an air cooling (for example a cooling rate of 5 Kelvin/sec to 70 Kelvin/sec) or for example a plate cooling can be carried out (cooling rates of more than 80 Kelvin/sec are easily achievable).

The resulting mechanical properties according to the invention are as follows:

| R_{p0.2} | 250 to 500 MPa |
|---|---|
| Rₘ | 400 to 900 MPa |
| A | ≥10%. |

FIG. 1 shows the differences with regard to the ratio of the elongation to the tensile strength Rₘ with a ferritic-perlitic structure (gray) and a dual-phase structure (black). It is clear that a dual-phase structure is very well-suited for the purposes according to the invention.

The following problems, however, occur when adjusting the alloy according to the prior art:

With high cooling rates in the cooling press, fully austenitically annealed dual-phase steels have unfavorable properties. FIG. 2 shows that with two different steels, namely one being a steel with 0.06% carbon and 1.2% manganese and another being a dual-phase steel with 0.08% carbon and 1.6% manganese, depending on the loading temperature, there is a very large spread with regard to the tensile strength R, of approx. 550 MPa to 880 MPa that is achieved in the steel with less carbon and less manganese.

Even in the steel with the higher carbon content and higher manganese content, the achievable tensile strength is from about 660 MPa to about 920 MPa. But this also means that with the variable loading temperatures and with the fluctuations in the loading temperature that are customary in the process, it is difficult to achieve reproducible strength values within the desired tolerances with the known dual-phase steels. The same is the case with the R_{p0.2} value, which fluctuates in a comparable way so that keeping these two important characteristic values within a manageable range is far from possible.

When it comes to the elongation, the same is true of the two steels, i.e. the elongation values fluctuate so significantly as a function of the loading temperature that with the known process windows, reliable target values cannot be achieved in conventional dual-phase steels. The structure of the lower-alloyed steel from the two graphic depictions is shown at a 750° loading temperature and a cooling rate that was achieved by means of water cooling.

FIG. 3 also shows that the depicted characteristic values, particularly when cooling with water, are highly dependent on the loading temperature and the cooling rate in the press, with the structure also differing significantly from the structure according to FIG. 2 since in FIG. 2, there is a much higher cooling rate.

FIG. 4 shows the influence of carbon on the above-mentioned characteristic values as a function of the loading temperature with the same manganese contents and the same aluminum contents. It is clear that with increasing carbon content, the strength and yield strength are increased. FIG. 5 shows that the ferrite quantity in the given steel decreases as a function of the carbon content with increasing carbon content.

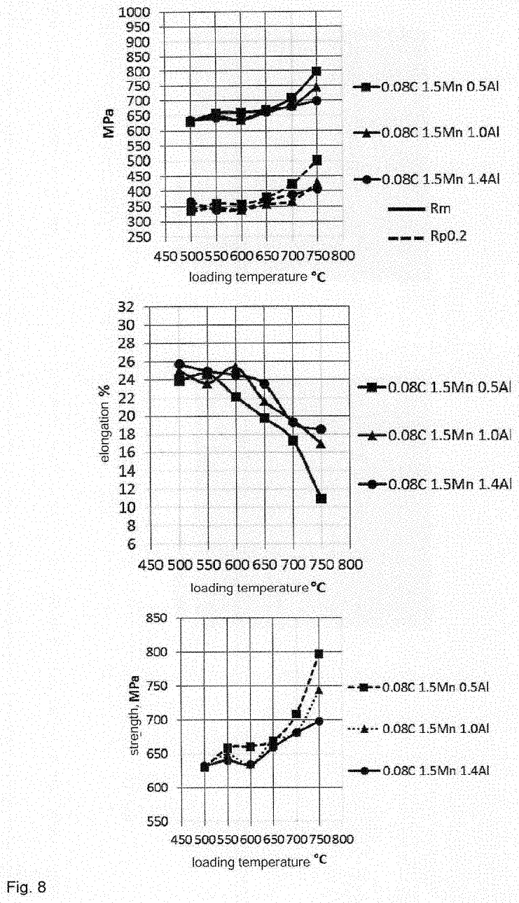

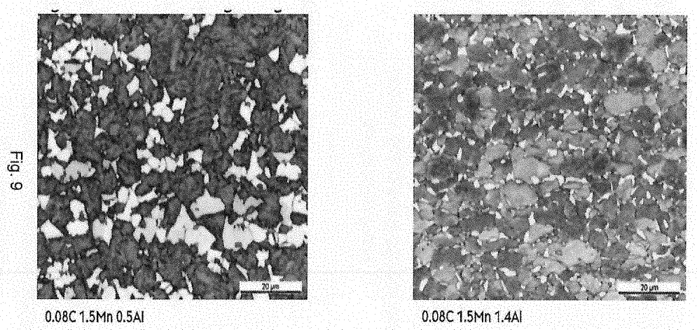

FIG. 6 and FIG. 8 show the influence of manganese with the same carbon contents and the same aluminum contents. As the manganese content increases, the strength and yield strength also increase whereas, as is clearly shown in FIG. 7, the martensite quantity in the structure increases and the ferrite quantity decreases.

The decisive factor for the invention is that an increasing aluminum content (FIGS. 8, 9) makes it possible to reduce the sensitivity to the loading temperature in the press. It is very clear in FIG. 8 that the tensile strength is less dependent on the loading temperature with a higher aluminum content than it is with 0.5% aluminum. This effect is even clearer in the R_{p0.2} value.

Also, a homogenization can be achieved with regard to the elongation. In the enlarged detail depicting the strength as a function of the loading temperature, it is once again very clear that the increasing aluminum content results in a significant homogenization.

FIG. 9 shows that the increasing aluminum content significantly increases the ferrite quantity. FIG. 10 shows that with fully austenitically annealed carbon/manganese alloys, at high loading temperatures, the strength depends to a massive degree on the cooling rate in the press; with intercritically annealed aluminum-alloyed dual-phase concepts, the dependence of the mechanical properties on both the loading temperature and the cooling rate of the press is significantly reduced, as is clear in the two diagrams in FIG. 10; on the left, a non-aluminum-alloyed steel is used and on the right, an aluminum-alloyed steel dual-phase steel is used.

According to the invention, in order to ensure the presence of a sufficient quantity of ferrite and thus a ferritic matrix in the dual-phase structure, it is sufficient to perform an intercritical annealing in the furnace so that in addition to austenite, ferrite is also present. For the soft partner material, i.e. the dual-phase steel, the Ac3 temperature must be kept high so that the intercritical annealing is even possible. According to the invention, this Ac3 value is increased by means of aluminum.

With the invention, it is thus advantageous that the favorable properties of dual-phase steel can be transferred to a method for press hardening or form hardening.

1. A method for producing a sheet steel component by means of a press hardening or form hardening process, comprising the steps of:
providing a steel sheet bar including a dual-phase steel; and
either a) cold-forming the steel sheet bar, then heating the steel sheet bar to an annealing temperature, then quenching the steel sheet bar in a cooling press, or b) heating the steel sheet bar to an annealing temperature, above an austenization temperature of the highly hardenable steel and forming and quenching the sheet bar using one or more strokes in a forming and cooling press;
wherein the dual phase steel has an Ac1 temperature and an Ac3 temperature, and the Ac3 temperature increases during the heating so that only partial austenization of the dual phase steel occurs, yielding a matrix that includes ferritic and austenitic components when the dual phase steel enters the cooling press.

2. The method according to claim 1, wherein the annealing temperature is greater than about 800° C. and less than the Ac3 temperature of the dual phase steel.

3. The method according to claim 1, wherein the heating step is performed in a furnace using a dwell time of between about zero and about 600 seconds.

4. The method according to claim 3, wherein one the Ac3 value of the dual-phase steel is high enough that the degree of austenitization occurring with the dwell time and the temperature is between 50 volume % and 90 volume %.

5. The method according to claim 1, wherein the quenching in a) orb) is performed at a cooling rate.

6. The method according to claim 1, wherein the steel sheet bar is formed using a press having a loading temperature between 450 and 850° C.

7. The method according to claim 6, wherein the loading temperature is 700° C. to 850° C.

8. The method according to claim 6, wherein the loading temperature is 400° C. to 650° C.

9. The method according to claim 5, wherein the cooling rate is ≥10 Kelvin/sec.

10. The method according to claim 1, wherein the dual-phase steel contains 0.5 to 1.5%.

11. The method according to claim 1, wherein the annealing temperature is set so that the dual-phase steel is intercritically annealed at a temperature between its Ac1 and Ac3 temperature.

12. A dual-phase steel material, comprising the following composition in mass %:

| | |
|---|---|
| C | 0.02-0.12%, |
| Si | 0.5-2.0%, |
| Mn | 0.5-2.0%, |
| Cr | 0.3-1.0%, |
| Al | 0.5-1.5%, |
| Nb | <0.10%, |
| Ti | <0.10% |

Residual quantities of iron and smelting-related impurities.

13. The material according to claim 12, wherein C=0.04-0.10 mass %.

14. The material according to claim 12, wherein Si=0.5-1.50 mass %.

15. The material according to claim 12 wherein Mn=0.60-1.50 mass %.

16. The material according to claim 12, wherein Cr=0.45-0.80 mass %.

17. The material according to claim 12, wherein Al=0.50-1.20 mass %.

18. A steel having a dual-phase structure, comprising:
a ferritic matrix; and
martensite inclusions embedded within the ferritic matrix;
wherein the steel comprises the following elements:

| | |
|---|---|
| C | 0.02-0.12%, |
| Si | 0.5-2.0%, |
| Mn | 0.5-2.0%, |
| Cr | 0.3-1.0%, |
| Al | 0.5-1.5%, |
| Nb | <0.10%, |
| Ti | <0.10% |

Residual quantities of iron and impurities.

19. The steel of claim 18, comprising:

| | |
|---|---|
| C | 0.04-0.12%, |
| Si | 0.55-1.50%, |
| Mn | 0.6-1.50%, |
| Cr | 0.45-0.8%, |
| Al | 0.6-1.20%, |
| Nb | 0.01-0.10%, |
| Ti | 0.01-0.10% |

20. The steel of claim 18, having the following properties:
R_{p0.2} of about 250 to about 500 MPa,
Rₘ of about 400 to about 900 MPa, and
A of greater than 10%.
